(19) United States
(12) Patent Application Publication
(10) Pub. No.: US 2003/0017441 A1
(43) Pub. Date: Jan. 23, 2003

(54) Field guide systems and methods for identifying features of nature

(76) Inventor: Jeffrey R. Greco, Fort Edward, NY (US)

Correspondence Address: HESLIN ROTHENBERG FARLEY & MESITI PC, 5 COLUMBIA CIRCLE, ALBANY, NY, 12203, US

(21) Appl. No.: 09/909,342

(22) Filed: Jul. 19, 2001

(51) Int. Cl. G09B 23/00

(52) U.S. Cl. 434/276

(57) ABSTRACT

The present invention provides field guide systems and methods for identifying features of nature. The system includes a plurality of field guide tags which include indicia relating to a plurality of features of nature. In the outdoors, the user may compare the indicia to features of nature which may include animal tracks, trees, wildflowers, animals, and insects, among others. The indicia on the field guide tags may include text or images relating to the above features of nature. For example, the indicia may include a ruler for measuring features of nature.

### TECHNICAL FIELD

This invention relates generally to educational tools and more particularly to field guide systems and methods for identifying features of nature.

### BACKGROUND OF THE INVENTION

When outdoors people often encounter natural objects such as plants or animals which they are not familiar with. The solution to this dilemma is often for a person to try to remember the appearance of the object and to research its identity in a bound field guide book. This approach may be frustrating because it can be difficult to remember the appearance of an object long enough to verify its identity through the field guide book upon a person's return to his home or office where such a guide book might be kept. One might simply bring the field guidebook with him in his outdoor pursuits. However, such a book might be bulky or might be easily ruined on exposure to the outdoors.

Thus, there is a need for educational tools, which are resistant to the elements present in the outdoors and which are easily transported by a user in the field for identification of features of nature.

### SUMMARY OF THE INVENTION

The present invention provides, in a first aspect, a field guide system for enabling a user to identify features of nature in the outdoors. The system includes a plurality of field guide tags which include indicia relating to a plurality of features of nature.

The present invention provides, in a second aspect, a method for identifying features of natures. The method includes providing a plurality of field guide tags which include indicia corresponding to features of nature. The method further includes comparing at least one indicia of at least one field guide tag to at least one feature of nature.

The present invention provides, in a third aspect, a system for identifying at least one feature of nature wherein the system includes a plurality of field guide tags detachably connected to one another wherein the plurality of field guide tags include means for identifying the at least one feature of nature.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention will be readily understood from the following detailed description of preferred embodiments taken in conjunction with the accompanying drawings in which:

FIG. 1 is a perspective view of a plurality of field guide tags, in accordance with the present invention;

FIG. 2 is a perspective view of one example of a field guide tag of FIG. 1;

FIG. 3 is a top view of the field guide tag of FIG. 2;

FIG. 4 is a bottom view of the field guide tag of FIG. 2;

FIG. 5 is a top view of another example of a field guide tag in accordance with the present invention;

FIG. 6 is a bottom view of the field guide tag of FIG. 5;

FIG. 7 is of a top view of another example of a field guide tag in accordance with the present invention;

FIG. 8 is a bottom view of the field guide tag of FIG. 7;

FIG. 9 is of a top view of a further example of a top view of a field guide tag in accordance with the present invention;

FIG. 10 is a bottom view of the field tag of FIG. 9;

FIG. 11 is a top view of yet a further example of a top view of a field guide tag in accordance with the present invention; and

FIG. 12 is a bottom view of the field guide tag of FIG. 11.

### DETAILED DESCRIPTION

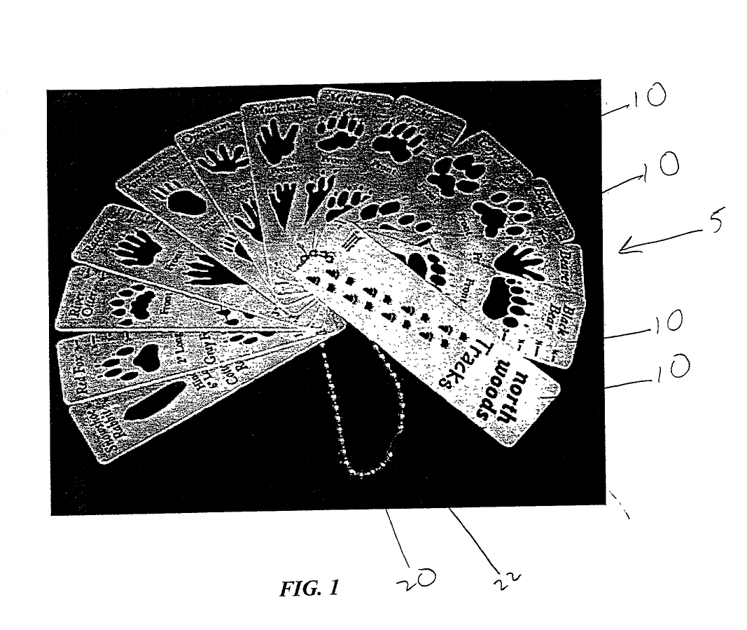

In accordance with the present invention examples of systems and methods for identifying features of nature are depicted in FIGS. 1-12 and described in detail herein.

FIG. 1 depicts one embodiment of a system 5 according to the present invention, which includes a plurality of field guide tags 10 connected by a cord 20.

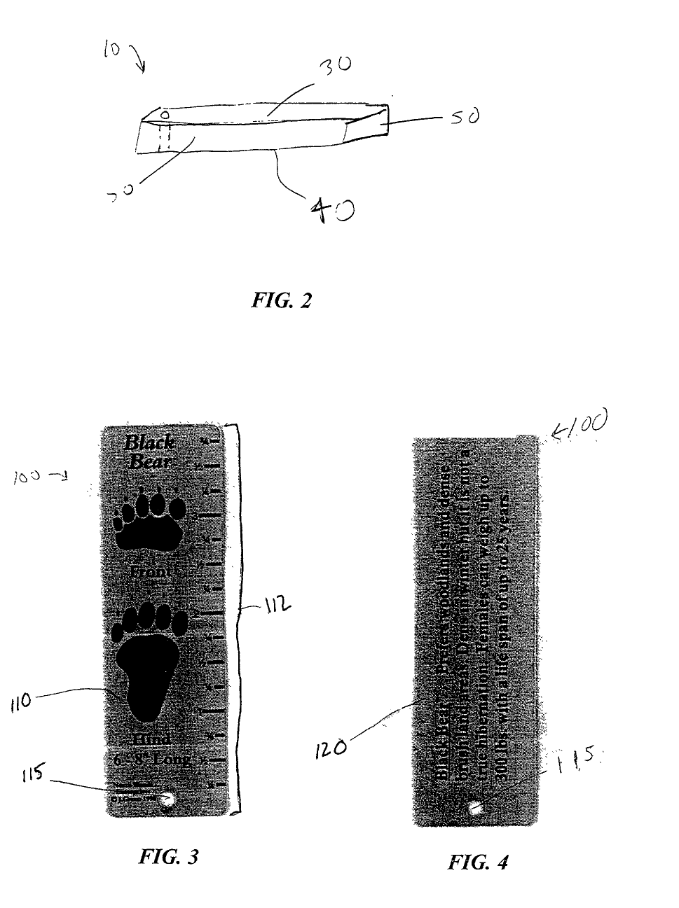

As illustrated in FIG. 2, field guide tags 10 include a top side 30, a bottom side 40, and an edge 50 which connects top side 30 and bottom side 40 on four sides thereof. Top side 30 and bottom side 40 may include text, photographs, drawings, images, or other indicia relating to natural environmental features. These indicia may thus be compared by a user to features found outdoors in the natural environment to identify the names of, or learn further information about such natural environmental features. For example, the indicia might be compared to features noticed while hiking, walking, or cross-country skiing.

FIGS. 3 and 4 depict an example of a first side 110 and a second side 120 of a field guide tag 100, respectively, in accordance with the present invention. First side 110 includes an image of a front and a hind footprint or track of a black bear along with printed text indicating typical sizes of the tracks of black bears. Further, first side 110 includes a ruler 112 disposed along a side thereof to measure a size of an animal track, for example a black bear, found by a user in the outdoors. The ruler may span the length of first side 110 and include increments of ¼ inch, for example. Second side 120 includes printed text describing information regarding habits, habitat, and typical sizes of black bears. The information on first side 110 and second side 120 may thus be compared to actual tracks found while hiking or walking in wooded areas, for example. First side 110 and second side 120 may also include an aperture 115 through which a chain, string, ball chain or other cord may be threaded to hold field guide tag 100 together with a number of other field guide tags.

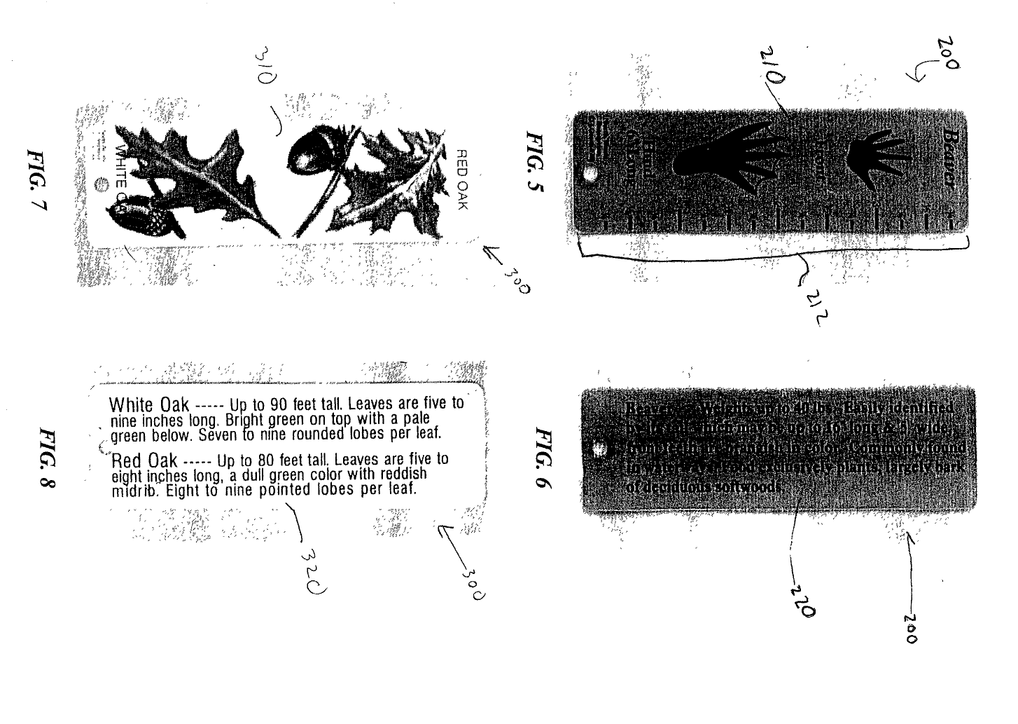

FIGS. 5 and 6 depict another example of a field guide tag 200 in accordance with the present invention. A first side 210 of field guide tag 200 depicts images of a front and a hind track of a beaver along with a ruler 212 for measuring animal tracks. A second side 220 of field guide tag 200 displays printed text describing information relating to traits of a beaver. Particularly, second side 220 includes information regarding a typical beaver such as the weight, length and width of the tail, color of the teeth, usual habitat, and food.

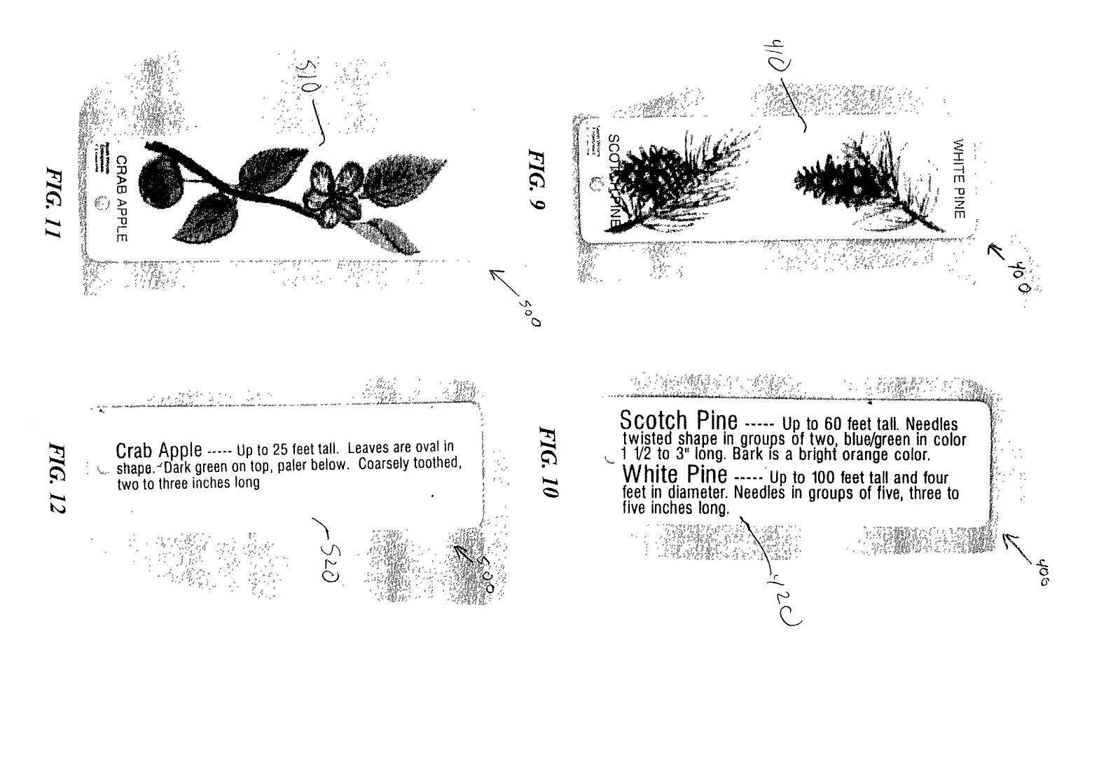

FIGS. 7 and 8 depict a further example of a field guide tag 300 including a first side 310 and a second side 320. First side 310 depicts an image of a leaf and an acorn of a red oak tree and a white oak tree, respectively. Second side 320 depicts textual information relating to the typical maximum tree height, typical leaf length, typical leaf coloring, typical leaf shape, and a typical number of lobes per leaf. FIGS. 9 and 10 depict another example of a field guide tag 400. A first side 410 depicts an image of pine needles and a pine cone of a white pine tree and a Scotch pine tree. A second side 420 illustrates textual information relating to these trees, specifically, a typical size of a tree, typical groupings of needles, typical coloring of needles, and a typical coloring of tree bark.

FIGS. 11 and 12 illustrate an example of a field guide tag 500 including a first side 510 and a second side 520. First side 510 illustrates a leaf, a flower, and a fruit of a crab apple tree. Second side 520 includes text providing information relating to the typical height, typical leaf shape, typical leaf length color, and typical leaf length of a crab apple tree.

As will be evident to those skilled in the art, field guide tags may including various indicia including images, text, drawings, and other means for use in comparison to plants, animals, stars, planets, other celestial bodies and other features, items, or objects found in the outdoors. Particular examples of subjects for field guide tags include trees, constellations, fish, moss, lichen, edible plants, insects, animal tracks, and fish. For example, the indicia might relate to various animal tracks such as those of a bobcat, coyote, dog, fishers, mink, muskrat, opossum and porcupine. Further examples relating to animal tracks include racoon, red fox, gray fox, river otter, skunk, snowshoe rabbit, cottontail rabbit, weasel, moose, whitetail deer, wild turkey and ruffled grouse. Each field guide tag may relate to one or more of these animals for example. Examples of trees which may be profiled on field guide tags include choke cherry, black cherry, beech, striped maple, quaking aspen, and red cedar. Further examples of trees include sugar maple, red maple, striped maple, beech, quaking aspen, balsam popular, basswood, hop hornbeam, white birch, yellow birch, gray birch, white ash, mountain ash, shagbark hickory, red spruce, red cedar, white cedar, hemlock, red pine, jack pine, pitch pine, balsam fir, tamarac, and staghorn sumac. Field guide tags may also include other supplemental information useful to a user. For example, a field guide tag may include textual information displaying definitions of terms used on other field guide tags.

Also, field guide tags may be attached to a user by a cord, chain, loop or other means to facilitate portability of the field tag tags. This is in marked contrast to the difficulties involved with carrying a field guide book or other while hiking, walking, cross-country skiing, or doing other outdoor activities. For example, field guide tags might be attached to a wrist of a user through opening and closing an openable link 22 (FIG. 1) in a ball chain holding the field tags or the same may be done to attach field guide tags to a user's equipment, such as a backpack, a fanny pack, coat, or other garment. In a further example, field guide tags may be inserted into a user's pants pocket, shirt pocket, coat pocket, fanny pack, or other such carrying portion.

Field guide tags may be made of various materials and may be substantially resistant to water. For example, field guide tags may be made of a plastic material or a high gloss vinyl material. These materials are resistant to water and thus may be used outdoors without a concern as to the effect of weather thereon. For example, a hiker may use field guide tags while hiking in the rain since rain would not harm them, but he would not likely use a field guide book in the rain since the book could be ruined by the water. Field guide tags also may be attached to the outer clothing or equipment of users because the elements would not likely have an adverse effect on them. Further, the field guide tags typically measure about 1¼ inches wide by 4 inches long by 1/32 inch thick, thus taking up less space than a typical field guide book in a user's pack. Field guide tags also may be flexible thereby contributing to their durability.

Additionally, a number of field guide tags may be fanned relative to one another, as illustrated in FIG. 1, so as to quickly facilitate comparison of features of nature to images or indicia on the several field guide tags. One field guide tag of the several field guide tags might also be rotated atop the remainder of the tags to maintain the several tags in a stacked arrangement, while the user compares information from the top field guide tag to an object found in the outdoors.

One example of a method for identifying features of nature is described as follows. Prior to beginning an excursion, for example, a hiker may choose several field guide tags relevant to a particular topic, for example, animal tracks as depicted in FIGS. 1-6. Field guide tags 10 may be detachably connected to one other using a cord having releasably attachable ends, for example, chain 20 with openable link 22, an illustrated in FIG. 1. These field guide tags may be arranged in a particular order, for example, with the most commonly used on top. Field guide tags 10 may be rotated one atop another on cord 20 or fanned one relative to another to allow more than one field guide tag to be viewed at a point in time. Indicia on the top or bottom surface of field guide tags 10 may be compared to an item found in the natural environment. As noted, field guide tags 10 may be rotated or fanned when being compared to a natural feature to facilitate comparison of field guide tags 10 to the feature of nature. For example, ruler 112 on top surface 110 of field guide 100 may be compared to an animal track to determine its length and the measured length might be compared to text and/or image information on the surface of one or more field guide tags (e.g., field guide tag 100 or field guide tag 200) to determine and confirm the type of animal which may have made the track. For example, images of the shapes of different animal tracks and their approximate lengths may be present on the surface of the several field guide tags. Similarly, the user may compare a leaf of a tree found while outdoors to one or more field guide tags (e.g., field guide tag 300, field guide tag 400, or field guide tag 500) having images of leaves and descriptions of different types of leaves and trees. A type of a particular tree may thus be determined. This process may be used for field guide tags having any of a variety of subjects.

The embodiments described herein are just examples. There may be many variations to the method and/or device described therein without departing from the spirit of the invention. For instance, the operational steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A field guide system for enabling a user to identify features of nature in the outdoors, said system comprising:
a plurality of field guide tags comprising indicia relating to a plurality of features of nature.

2. The system of claim 1 wherein said plurality of field guide tags comprises substantially water resistant material.

3. The system of claim 2 wherein said plurality of field guide tags comprises a plastic material.

4. The system of claim 1 wherein said plurality of field guide tags comprises substantially flexible material.

5. The system of claim 1 wherein each tag of said plurality of field guide tags is connected to said plurality of field guide tags by a cord.

6. The system of claim 5 wherein said cord further comprises a first end and a second end releasably attachable to each other to allow at least one of an addition of at least one supplemental tag to said plurality of field guide tags and a removal of at least one surplus tag from said plurality of field guide tags.

7. The system of claim 1 wherein said indicia comprises at least one image of an animal track.

8. The system of claim 1 wherein said indicia comprises a ruler.

9. The system of claim 1 wherein said indicia comprises at least one description of an identifying characteristic of at least one type of animal.

10. The system of claim 9 wherein said at least one description comprises information relating to at least one of a weight, a height, a coloring, a food, a habitat, a habit, a life span, a defense mechanism, a mating ritual, and a dimension of said at least one type of animal.

11. The system of claim 1 wherein said indicia comprises an image of at least a portion of at least one tree.

12. The system of claim 1 wherein said indicia comprises an image of at least one of a leaf and a needle of at least one tree.

13. The system of claim 1 wherein said indicia comprises at least one description of at least one identifying characteristic of at least one tree.

14. The system of claim 11 wherein said description comprises information relating to at least one of a maximum tree height, a dimension of a leaf, a dimension of a needle, a leaf color, a grouping of needles, a shape of a needle, a cone length, a type of bark or trunk, a color of a cone, a type of fruit, a timing of fruit maturation, a description of leaf shape and a criteria for comparison between types of trees.

15. The system of claim 1 wherein each of said plurality of field guide tags includes a first side and a second side, and wherein at least two of said plurality of field guide tags comprise a substantially identical shape and comprise substantially similar dimensions.

16. The system of 13 wherein said first side and said second side of each of said plurality of tags comprise dimensions of about 1¼ inch by about 4 inches.

17. The system of claim 1 wherein said indicia comprises at least one of an image and text relating to a least one of constellations, fish, moss, lichen, edible plants, insects, animals and wildflowers.

18. The system of claim 1 wherein said plurality of field guide tags is adapted to be attached to at least one of the user, the user's clothing and the user's equipment.

19. A method for identifying a plurality of features of nature in the outdoors, the method comprising:
providing a plurality of field guide tags comprising indicia corresponding to the features of nature; and
comparing at least one indicia of at least one field guide tag to at least one feature of nature of the plurality of features of nature.

20. The method of claim 19 further comprising identifying the at least one feature of nature based on the comparison.

21. The method of claim 19 further comprising attaching the plurality of field guide tags to at least one of a user and the user's clothing.

22. The method of claim 19 wherein the indicia comprises at least one image of at least a portion of an animal.

23. The method of claim 19 wherein the indicia comprises a ruler and the comparing comprises measuring a first feature of nature of the plurality of features of nature using the ruler.

24. The method of claim 23 wherein the first feature of nature comprises an animal track and the measuring comprises measuring a dimension of the animal track using the ruler.

25. The method of claim 24 wherein the indicia further comprises a measurement criteria and the comparing further comprises comparing a result of the measuring to the measurement criteria.

26. The method of claim 19 wherein the indicia comprises an illustration of an animal track, a first feature of nature of the plurality of features of nature comprises an animal track, and the comparing comprises comparing the indicia to the animal track.

27. The method of claim 19 wherein the indicia comprises at least one description of an identifying characteristic of at least one animal.

28. The method of claim 26 wherein the at least one description comprises information relating to at least one of a weight, a height, a coloring, a food, a habitat, a habit, a life span, a defense mechanism, a mating ritual, and a dimension of at least one type of animal.

29. The method of claim 19 wherein the indicia comprises an image of at least one of a leaf and a needle of a tree.

30. The method of claim 19 wherein the indicia comprises at least one description of identifying characteristics of at least one tree.

31. The method of claim 30 wherein said the description comprises text information relating to at least one of a maximum tree height, a dimension of a leaf, a dimension of a needle, a leaf color, a grouping of needles, a shape of a needle, a cone length, a type of bark or trunk, a color of a cone, a type of fruit, a timing of fruit maturation, a description of leaf shape, and a criteria for comparison between types of trees.

32. The method of claim 19 wherein the indicia comprises at least one of an image and text relating to a least one of constellations, fish, moss, lichen, edible plants, insects, plants, animals and wildflowers.

33. The method of claim 32 further comprising connecting said plurality of field guide tags to one another using a cord.

34. The method of claim 33 wherein the cord comprises a first end and a second end wherein the first end is detachably connectable to the second end, and wherein the method comprises at least one of adding a substitute field guide tag and removing a surplus field guide tag, and connecting the first end to the second end.
